(19) United States
(12) Patent Application Publication
(10) Pub. No.: US 2023/0052276 A1
(43) Pub. Date: Feb. 16, 2023

(54) Hair Extension Subscription Service, Method of Providing Hair Extension Subscription Service

(71) Applicant: Schoquilla Lashawn Coleman, Yonkers, NY (US)

(72) Inventor: Schoquilla Lashawn Coleman, Yonkers, NY (US)

(73) Assignees: Schoquilla Lashawn Coleman, Yonkers, NY (US); Diva Hair Box, LLC, Yonkers, NY (US)

(21) Appl. No.: 17/946,033

(22) Filed: Sep. 16, 2022

(51) Int. Cl. G06Q 30/06; G06Q 10/08

(52) U.S. Cl. CPC G06Q 30/0633; G06Q 10/083

(57) ABSTRACT

The present invention relates to a method for providing hair extension subscription services, and more specifically providing do it yourself hair kits. A packaged hair kit includes a hair box, a hair storage bag, hair extensions, hair accessories, hair supplies, and instructions on how to install hair kit.

### BACKGROUND

The present disclosure relates to hair extension subscription services. More specifically, embodiments of the present disclosure relate to do it yourself hair kit.

Hair extensions and hair supplies are typically based through a conventional and manual system, in which customers are required to go to a hair salon, hair supply store, or order individual hair products online.

These types of inventory models suffer from several significant limitations. First, conventional hair salons and hair supply stores require customers to physically go to the store, customers are required to make the decision of which items to purchase from an overwhelming amount of product options.

An example that illustrates this limitation is a hair supply business. Customers must undergo the burden of physically going into a hair business in order to receive a service, then undergo the extensive processive of selecting particular hair styles and products to purchase. In this situation, the customers can not decide which style or products to choose from. The customers may have a particular hair style in mind, but there is no guarantee that this particular hairstyle will be in stock.

The customers take the products home, if there is any error with the order, customers must return them by a particular due date or be penalized. Moreover, this is inconvenient for customers resulting in an unpleasant hair extension experience.

Given the current demand for hair extension subscription, limitations in the prior approaches, an approach for delivering items to customers that does not suffer from limitations associated with conventional models is highly desirable. In particular, an approach for providing diy hair kits, and assembling all products allows separation of customers' decisions of what items and styles to purchase is highly desirable.

There is a further need for an approach for providing hair extension subscription services to customers on a continuous basis that limits the need for customers to physically go into a salon or store and wait to be serviced.

There is a further need for an approach for hair extension subscription services to customers that curates products needed alleviating the customer from making the decision of which items to purchase from an overwhelming amount of product options.

There is yet a further need for an approach for hair extension subscription services, to provide beginner friendly instructions and guides to customers, to be able to deliver products to customers that are more convenient, and flexible to customers than conventional approaches.

The present disclosure relates to hair extension subscription. More specifically, embodiments of the present disclosure relate to a packaged hair kit.

### SUMMARY OF THE INVENTION

The present invention relates to a method for providing hair extension subscription services, and more specifically providing do it yourself hair kits. A packaged hair kit includes a diva hair box, a hair storage bag, hair, hair accessories, hair supplies, and instructions on how to install hair kit.

Hair kit delivery services are a new and innovative means for hair delivery and installation. Hair kits provide consumers with a greater variety, flexibility, and cost efficient means for “completing hairstyles” at home. Hair supplies, and hair accessories, as well as instructions for installing hair at home are provided in the delivered hair kit. Hair kit delivery services are a modern alternative to going to the beauty supply store or going to the salon.

In some embodiments, a packaged hair kit includes a diva hair box, a hair storage bag, hair, hair accessories, hair supplies, and instructions on how to install the hair kit.

According to one aspect of the invention, a method is provided for hair extension subscription services. New customers or beginners complete a survey. In response, hair kits are curated, and delivered to customers on a subscription basis.

According to one aspect of the invention, a method is provided for hair extension subscription services. According to the method, to limit customers selecting from a variety of hair extensions and products.

According to one aspect of the invention, an apparatus for hair extension subscription services. According to the method, customers are able to bring the salon experience home. A method is also provided for beginners, step by step tutorials on how to install hairstyle like a professional with all supplies included.

According to one aspect of the invention, a method is provided for hair extension subscription services. According to the method, for convenience, customers no longer have to order products individually, customers can bundle items together for a bigger discount.

According to one aspect of the invention, an apparatus for hair extension subscription services. According to the method, to expand employment opportunities.

### BRIEF DESCRIPTION OF THE DRAWINGS

Various ones of the appended drawings merely illustrate example embodiments of the present disclosure and should not be considered as limiting its scope.

Embodiments of the invention are illustrated by way of example, and not by way of limitation, in the figures of the accompanying drawings refer to similar elements and in which:

FIG. 1 is a diagram depicting an approach for hair extension subscription items to customers according to an embodiment.

FIG. 2 is a flow diagram depicting an approach for subscribing items to customers according to an embodiment.

FIG. 3 is a diagram depicting an approach for subscribing items to customers according to an embodiment.

### DETAILED DESCRIPTION OF THE INVENTION

In the following description, for the purposes of explanation, specific details are set forth in order to provide a thorough understanding of the invention. However, it will be apparent that the invention may be practiced without these specific details. In other instances, well-known structures and elements are depicted in block diagram form in order to avoid unnecessarily obscuring the invention. Various aspects and features of example embodiments of the invention are described in more detail hereinafter in the following sections: (1) functional overview; (2) item selection criteria; (3) item delivery; (4) inventory management; and (5) implementation mechanisms.

### 1. Functional Overview

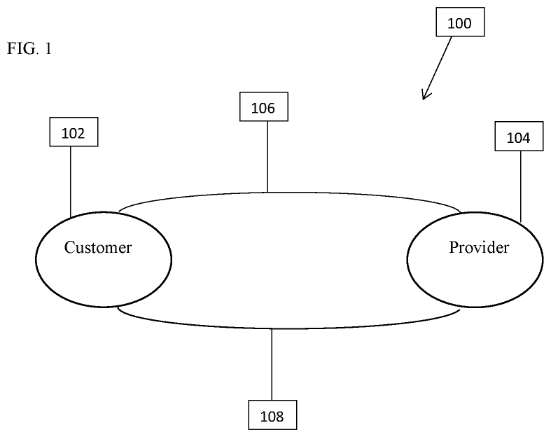

FIG. 1 is a block diagram 100 that illustrates an approach for subscribing items to customers according to various embodiments described herein. As used herein, the term “items” refers to any commercial goods that can be sold to customers. Examples of items include hair extensions, hair products and hair supplies.

The invention is not limited to any particular type of items In general, the decision of what items customers receive is based on a questionnaire. Customers may specify what items they receive and when to receive the specified items. Furthermore, customers are not constrained by conventional timeframes and instead can have continuous, serialized items.

According to one embodiment, a customer 102 Provides one or more item selection criteria to a provider 104 over a link 106. Link 106 may be any medium for transferring data between customer 102 and provider 104 and the invention is not limited to any particular medium. Examples of link 106 include, without limitation, a network such as a LAN, WAN or the Internet, a telecommunications link, a wire or optical link or a wireless connection.

The item selection criteria indicate items that customer 102 desires from provider 104. In response to receiving the item selection criteria from customer 102,

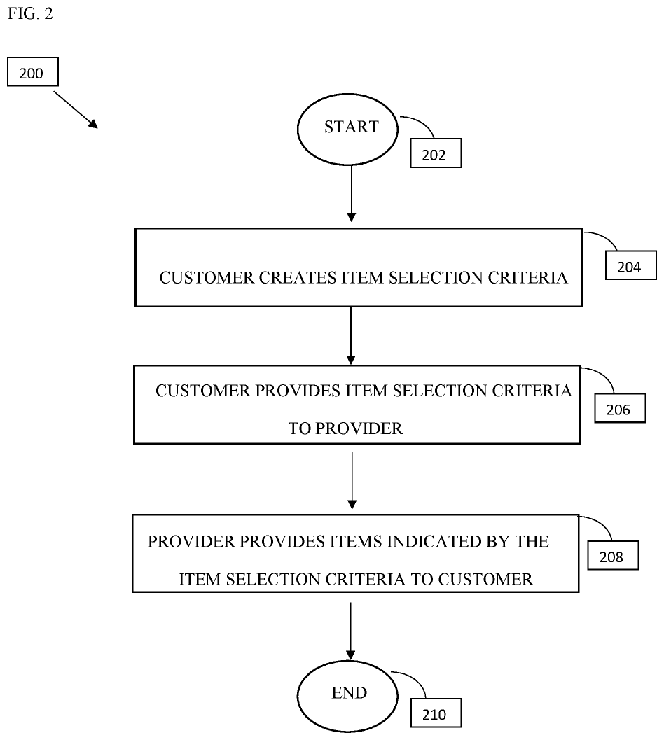

The approach just described for hair extension subscriptions to customers, is now described with reference to a flow diagram 200 of FIG. 2. After starting in step 202, in step 204, customer 102 creates item selection criteria. In step 206, customer 102 provides the item selection criteria to provider 104. In step 208, in response to provider 104 receiving the item selection criteria from customer 102, provider 104 provides items indicated by the item selection criteria to customer 102. The process is complete in step 210.

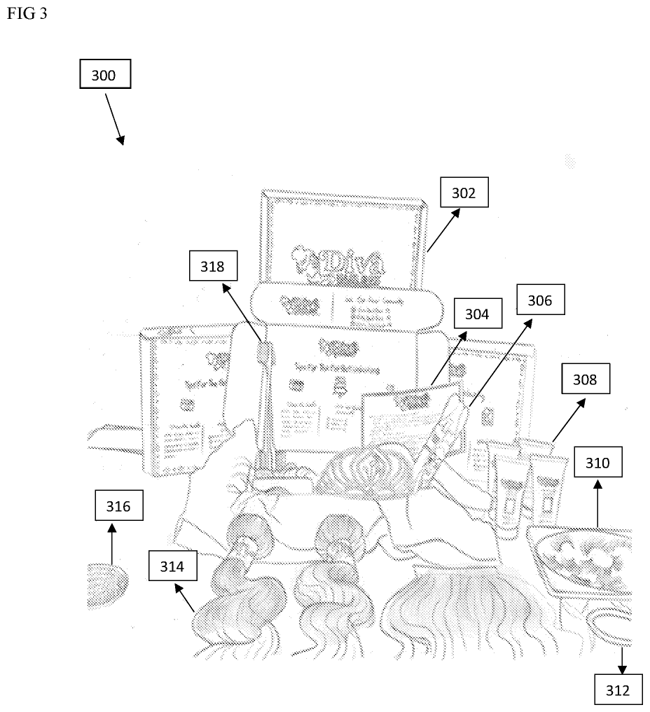

The approach described for hair extension subscriptions to customers, is now described with reference to a diagram 300 of FIG. 3. After starting in step 208, in step 302, customer 102 receives delivered item selection products. In item selection customer selected In step 206. The process is complete in step 318.

### 2. Item Selection Criteria

The item selection criteria provided by customer 102 to provider 104 indicate the particular items that customer 102 desires from provider 104. Thus, the item selection criteria define a customer-specific order that is fulfilled by provider 104. According to one embodiment, the item selection criteria specify attributes of items to be provided by provider 104 to customer 102. Item selection criteria may specify any type of item attributes and the invention is not limited to particular item attributes. Examples of item attributes include, without limitation, identifier attributes, type attributes and cost attributes. Item selection criteria may be changed at any time to reflect changes in items that customers desire from a provider.

The item selection criteria provided by customer 102 to provider 104 indicate the customer-specific items in 302 that customer 102 desires to have delivered from provider 104. In item selection customer selected Diy hair kit 302, instruction card 304, wig cap 306, hair glue 308, eyelashes 310, compact mirror 312, hair extension 314, hand brush 316, edge brush and comb 318.

The appended example embodies the present disclosure and should not be considered as limiting its scope. Embodiments of the invention are illustrated by way of example, and not by way of limitation.

### 3. Item Delivery

According to one embodiment, items are delivered by provider 104 to customer 102 over delivery provider 108 based upon item delivery criteria. More specifically, the delivery of items from provider 104 to customer 102 is triggered by item delivery criteria being satisfied. The item delivery criteria may include a wide range of criteria and the invention is not limited to any particular item delivery criteria, examples of item delivery criteria include, without limitation, customer request notification, customer payment, customer return of an item, the occurrence of a specified date, the elapsing of a specified period of time or a customer payment.

The item delivery criteria may be specified by customer 102 to provider 104 as part of a subscription service. For example a particular subscription service may include item delivery criteria that specifies that particular items are to be delivered monthly, another item delivery criteria may specify that an initial set of items is to be delivered by provider 104 to customer 102 upon initiation of a subscription service and that additional items are to be delivered to customer 102 monthly, item delivery criteria may be applied uniformly to all items to be delivered to a customer, or may be item specific. For example, item delivery criteria may specify a particular date, i.e., the third Wednesday of every month, for all item deliveries. Alternatively, separate item delivery dates may be assigned to each item.

### 4. Inventory Management

The approach described herein for hair extension subscription services provides superior inventory management to prior approaches. Specifically, the use of item selection criteria provides for efficient inventory management by allowing items to be purchased at any given time. Moreover, the greatest number of customers are provided with their most preferred items.

According to one embodiment, based on item selection, inventory is monitored and maintained. For example, referring again to FIG. 1, the item selection criteria provided by customer 102 to provider 104 indicate the particular items that customer 102 desires from provider 104. Items are then managed.

### 5. Implementation Mechanisms

The approach described herein for providing items to customers is applicable to any type of hair extension subscription and (without limitation) is particularly well suited for Internet-based applications for providing hair extension subscription products to customers. The invention may be implemented in hardware circuitry, in computer software, or a combination of hard-ware circuitry and computer software and is not limited to a particular hardware or software implementation.

The approach described herein for providing hair extension items to customers provides several advantages over prior approaches for providing hair products to customers. First, the decision of what products to purchase may be separated from the decision of when to purchase these items. Customers may specify which products to select using the item selection criteria and receive the products at a future point in time, without having to go to the provider to pick up the products.

The selection criteria may be user specific and may indicate a desired fulfillment sequence. Furthermore, customers are not constrained by conventional methods and instead may establish continuous, serialized items for subscription. The approach also allows more efficient inventory management.

The approach for inventory management maintains inventory items that are periodically replaced by other items according to specified criteria.

In the foregoing specification, the invention has been described as applicable to an implementation anticipating Internet based ordering and mail or other long-distance delivery of hair extension subscription service, where the special advantages of the method are very attractive. However the same invention may be applied in a more unconventional method, where subscription customers may be allowed to create their own diy hair box, complete with all hair supply needed at any time, and/or in one subscription period, without further subscription commitment, in exchange for a one time subscription fee.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

1. A method for providing hair extension subscription service to customers, the method comprising the steps of DIY hair kits.

2. A method as recited in claim 1, further comprising of receiving items from selection criteria that indicates items that a customer desires to wear.

3. An apparatus as recited in claim 1, wherein items will be delivered to the customer, within a specified occurrence in time, indicated by item selection criteria.
